(19) United States
(12) Patent Application Publication
(10) Pub. No.: US 2017/0299874 A1
(43) Pub. Date: Oct. 19, 2017

(54) VyO Vision

(71) Applicant: Catherine Jones, Forest Park, IL (US)

(72) Inventor: Catherine Jones, Forest Park, IL (US)

(21) Appl. No.: 15/098,306

(22) Filed: Apr. 13, 2016

(51) Int. Cl. G02B 27/01; B60K 35/00; G06F 3/041

(52) U.S. Cl. CPC G02B 27/0189; G06F 3/041; B60K 35/00; G02B 27/0101; B60K 2350/908; B60K 2350/901; B60K 2350/352; B60K 2350/2052; G02B 2027/011; G02B 2027/0127; G02B 2027/0141; B60K 2350/965

(57) ABSTRACT

VyO Vision invented to allow drivers the option to adjust the windshield or electrical device per preference for better viewing while driving either vehicles, trains, aerospace, aircraft, boats, submarines, and military windshields, binoculars, telescopes, security cameras, house windows, door peepholes, race cars, all motorized vehicles.

VyO Vision windshield: can be used like wearing eye glasses, better viewing while driving, flying a plane, while preventing stress on eyes caused by extensive use that could later cause vision damage, headaches and later forced to wear eyeglasses etc.

### CROSS-REFERENCE TO RELATED APPLICATIONS

Ser. No. 13/630,217

### STATEMENT REGARDING FEDERALLY SPONSORED RESEARCH OR DEVELOPMENT

N/A

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Reference material submitted as Text.

### STATEMENT REGARDING PRIOR DISCLOSURES BY THE INVENTOR OR A JOINT INVENTOR

VyO Vision invented to assist drivers various optical options per the driver's preference toward better viewing while operating any and motorized vehicles.

### BACKGROUND OF THE INVENTION

On an average there are many accidents occurring on a daily basis, and many are caused because of vision impairments, weather, or physically tired. VyO Vision would allow drivers the option to assist towards safer driving while providing better viewing. At any legal driving age, VyO Vision provides relief off the driver's eyes with corrective options to zoom in or out, including utilizing the various options to focus better either for reading street signs, and other vehicles.

Whether an individual wear eye glasses or not VyO Vision would help toward driving safer. At any age VyO Vision would restore confidence in drivers by providing various option to adjust and operate many specifications implemented in the windshield. VyO Vision will also provide the option to utilize audio alerts that will alert driving either approaching objects or objects approaching the vehicles within distance of 500 feet or closer.

### (1) Field of the Invention

The invention is a system that would allow motorists to adjust various optical options by preferences implemented in the windshield for all motorized vehicles to view better while operating. Including audio alerts to drivers of objects nearing any vehicles and vehicles nearing objects in various distances set by the driver's preferences.

### (2) Description of Related Art Including Information Disclosed Under 37 CFR 1.97 and 1.98

VyO Vision can be either as an electrical device in the form of a tablet or implemented in the windshield as touch screen to operate by drivers either during driving or before driving. To activate and operate VyO Vision the motorize vehicle ignition must be on. VyO Vision invented to provide options to drivers to select how each preference of better viewing options for safe driving.

### BRIEF SUMMARY OF THE INVENTION

VyO Vision assist motorist various adjustment on any windshield for better viewing while operating or before operating motorize vehicles. With various enhancements implemented or integrated on aircraft, vehicles, military equipment, house windows, door peep holes, trains, space shutter, binoculars, security cameras, telescopes, motorcycles, buses, scuba diving goggles or any type of engine operated vehicles. VyO Vision will have Implement audio alerts to warn motorist objects approaching the vehicles and alarming motorist if approaching objects within various distance per drivers preference.

### BRIEF DESCRIPTION OF THE SEVERAL VIEWS OF THE DRAWING(S)

Referring to the following descriptions of the embodiments may be better understood accompany drawings as numerically indicated with the functionally listed as follows:

FIG. 1 shows: is 8 push buttons located at the top right side of the electrical device or glass windshield to select Dioptre levels of strengths: +1.00 thru +3.25

FIG. 2 shows: is 3 push buttons for zoom, distance, and near adjustments located at the top right side of the electrical device near the left side of FIG. 1

FIG. 3 shows: is 1 sliding button that clicks with 2 push buttons to adhere the choice of cylinder and or axis adjustment blurred vision based on drivers preference. Located bottom of the electrical device or windshield

FIG. 4 shows: is either 1 or 3 push button (s) for the O.D Dexter, O.S Sinister, and O.U Uterque located under FIG. 2 on the right side of either the electrical device or windshield (Optional Rx Prescription)

FIG. 5 shows: is 2 push buttons for near or far viewing of Spherical located on the right side under of either the electrical device or windshield

FIG. 6 shows: is 1 sliding button or 3 push buttons for various options to select bifocal, trifocal and progressive located on the right side of the electrical device or windshield near the right side of FIG. 3

FIG. 7 shows: is 1 push button or 1 sliding button to Pupilary distance between the center of each pupil located under the electrical device or lower bottom of the windshield

FIG. 8 shows: is 1 push button or sliding button for PL/Plo/Plano located on the right side of the electrical device or windshield placed under the millimeter sensor or under FIG. 5

FIG. 9 shows: is 1 push button Prism to compensate eye alignment located on the bottom of the electrical device or windshield optional

FIG. 10 shows: is 1 push button or touch screen or wired in the dash board for DV—Distance vision optional installed located top left of electrical device or windshield

FIG. 11 shows: is 1 push button to select either NV/NVO near vision or near vision only located under FIG. 10 DV Distance on the left side of the electrical device

FIG. 12 shows: is the Sensor Millimeter Ruler Sensor located in the center of the electrical device or windshield for self-measurement of the center driver's eye pupils

### DETAILED DESCRIPTION OF THE INVENTION

VyO Vision will be used for vehicles, trains, aerospace, aircraft, boats, submarines, and military windshields, binoculars, telescopes, security cameras, house windows, door peepholes, race cars, all motorized vehicles.

VyO Vision windshield: can be used like wearing eye glasses, better viewing while driving, flying a plane, while preventing stress on eyes caused by extensive use that could later cause vision damage, headaches and later forced to wear eyeglasses etc.

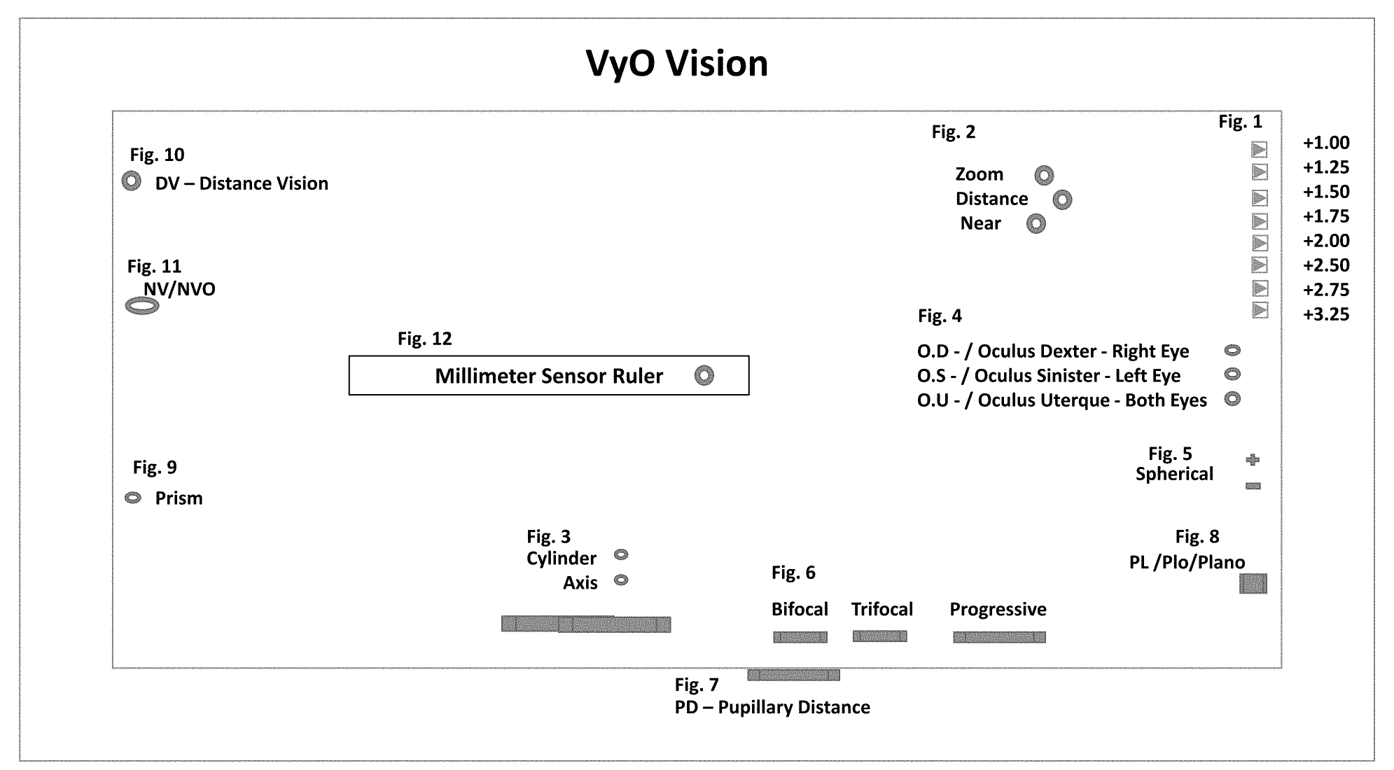

VyO Vision is glass used to help people see at different levels. VyO Vision is preferably adjustable. For example: VyO Vision windshield on any vehicle will help a person to see well. Sometimes the naked eye or wearing eyeglasses can make images look blurred, far away and not clear, but with VyO Vision; hard to see areas can become clearer especially with the zooming options. No more worries, if you lose or forget your glasses, and have to drive or read street signs with just a few adjustments, and or clicks VyO Vision can make driving more comfortable and safer. VyO Vision will restore independence for elderly drivers along with confidence because VyO Vision will help them to see better while driving especially when eye glasses are not enough. VyO Vision will also assist people who has partial vision impairments. A clear vision with VyO Vision will prevent vehicle accidents, and take stress and pressure off eyes from extensive use whether you wear eye glasses or not. As illustrated FIG. 1 shows: is 8 push buttons located at the top right side of the electrical device or glass windshield to select Dioptre levels of: +1.00 thru +3.25 to adjust optical viewing while operating the motorize vehicles. The electrical device or windshield with the option to adjust for nearsightedness and farsightedness. FIG. 2 zoom, distance and near option assisting drivers viewing closer or adjustable viewing avoiding straining eyes while operating any motorized vehicle. FIG. 3 option for cylinder and axis optional for drivers to adjust the windshield or electrical device as a single-vision either with prescription or without to improve reading street signs. FIG. 4 implemented in windshield or electrical device for oculus sinister, dexter, or uterque for viewing while operating motorized vehicles each option can be prescribed by an optometrist. FIG. 5 is spherical adjustable to near-sighted in the windshield or optional in the electrical device. FIG. 6 is bifocal, trifocal, and progressive option in the windshield providing the drivers to use the windshield as eye glasses either partial windshield or whole. FIG. 7 is pupillary distance used between the center of the drivers eyes if drivers required bifocal in one and not both eyes while driving. FIG. 8 is pl, plo, piano option not adjustable normally only zeroes are entered toward better viewing for drivers. FIG. 9 is prism implemented either in the electrical device or windshield that will compensate with eye alignment for better viewing while driving any vehicle. FIG. 10 is dv distance vision will allow drivers to adjust the windshield or electrical device to view any object either closer or far while operating any motorized vehicle. FIG. 11 is nv or nvo the option to adjust the windshield or electrical device for viewing near viewing adjustable or preset near vision only without adjustable settings. FIG. 12 Normal view is millimeter ruler sensor implemented either in electrical device or windshield to take record of the distance between the driver's eyes for alignment viewing. All options operated on device either touched screen on the windshield, wired in the vehicle dash-board, or in electrical device installed in all motorized vehicles; with the option to activate VyO Vision partial windshield or whole. The drivers will have all three options: standard windshield without VyO Vision activated or partial windshield or whole windshield activated with VyO Vision.

### VyO Vision Purpose and Story

I noticed some of my family members and friends refuse to learn how to drive because of visibility (especially the younger and elderly generation). My great niece explained she never had the confidence to learn how to drive. I explained VyO Vision and what it does immediately she stated, “VyO Vision would give me the confidence I've been longing for”!

In the year of 2014, I was driving in the Deep South a deer barely missed my truck. My daughter was in a plane and right after takeoff two birds flew in the plane shafts which cause the plane to divert back to the airport. For these reasons including assisting drivers toward driving safer, I know VyO Vision will make a difference!

### Specifications

(FIG. 1) 8 buttons—Dioptre various strengths—Located top right side of device or windshield

Enabling Drivers to Select Correct Optical Power for Better Viewing in the Windshield

+1.00 Strength—Dioptre are units of measurements of the optical power of the windshield enabling the driver to use corrective strengths for better viewing while driving

+1.25 Strength—Dioptre are units of measurements of the optical power of the windshield enabling the driver to use corrective strengths for better viewing while driving

+1.50 Strength—Dioptre are units of measurements of the optical power of the windshield enabling the driver to use corrective strengths for better viewing while driving

+1.75 Strength—Dioptre are units of measurements of the optical power of the windshield enabling the driver to use corrective strengths for better viewing while driving

+2.00 Strength—Dioptre are units of measurements of the optical power of the windshield enabling the driver to use corrective strengths for better viewing while driving

+2.50 Strength—Dioptre are units of measurements of the optical power of the windshield enabling the driver to use corrective strengths for better viewing while driving

+2.75 Strength—Dioptre are units of measurements of the optical power of the windshield enabling the driver to use corrective strengths for better viewing while driving

+3.25 Strength—Dioptre are units of measurements of the optical power of the windshield enabling the driver to use corrective strengths for better viewing while driving

(FIG. 2) 3 buttons—Zoom, Distance, and Near buttons in the windshield Located at the top of the left of the right side of the FIG. 1 8 Dioptre buttons on the device or windshield

Enable Drivers to Use the Zoom, Distance and Near Buttons in the Windshield

Zoom Button—Provide drivers variable focal view lengths (28 mm wide angle to 135 mm zoom)

Distance—Enable drivers to view objects from a distance usually 20 feet (6 m) or more

Near—Enable drivers to view objects 2 feet or closer

(FIG. 3) 1 Slide button that clicks twice or 2 buttons—(Optional based on drivers preference)—Right and Left button—Cylinder and Axis—Located at the bottom on the right side of FIG. 9 Prism left side button on the device or the windshield

Enable Drivers to Use Either or Both CYL-/Cylinder or Axis Optional in the Windshield

CYL-/Cylinder—Enable drivers the option to adjust corrective power levels for astigmatism (if applicable)

Axis—Enable driver's corrective axis for astigmatism (the adjustable angle between 0 and 180 degrees (if applicable)

(FIG. 4) 1 or 3 buttons Optional based on drivers preference)—Oculus Dexter (right eye), Oculus Sinister (left eye), Oculus Uterque (both eyes)—Located on the right side of the device or windshield under FIG. 1 Dioptre 8 buttons

Enable Drivers the Option to Adjust Manually or Implement His or Her Optometrist RX—Your Prescription in the Windshield or Device

O.D-/Oculus Dexter—Right Eye

O.S-/Oculus Sinister—Left Eye

O.U-/Oculus Uterque—Both Eyes

(FIG. 5) 2 buttons—near (−) or far (+)—Spherical—Located on the right side under of the device or the windshield under FIG. 4 Oculus Dexter, Oculus Sinister, and Oculus Uterque

Enable Drivers the Option to Adjust Near or Far Sightedness in the Windshield

SPH-/Spherical—Enable the drive corrective power for distance or reading (near (−) or far (+) sightedness)

(FIG. 6) 1 slide button or 3 buttons to select—Bifocal/Trifocal/Progressive windshield—Located close to right side of the device or windshield on the right side of FIG. 3 Cylinder and Axis

Enable Drivers to Adjust Either to: Add/Add Power—Magnification for Reading (Preferable or if Applicable Either the Bottom Half of the Windshield Portions, or Whole)

Bifocal—windshield d with two parts with different focal lengths

Trifocal—windshield with trifocal lengths

Progressive windshield—windshield transitioning between different focal lengths while correcting viewing for drivers at all distances

(FIG. 7) 1 buttons or 1 slide button to select—(Optional Installation) PD—Pupillary Distance or the distance between the centers of each pupil (in mm) or (1 button for read only Optional)—Located under the device or on the windshield

Enable the Driver to Measure the PD Pupillary Distance or the Distance Between the Centers of Each Pupil (in mm) Distance, Intermediate, Bifocal Windshield, Varifocal Windshield

(FIG. 8) 1 button or slider touch screen or wired (Installation Optional) with 3 options to select or enter number—PL/Plo/Plano—combining form level; flat Located on the right side of the device or windshield under the Millimeter sensor or under FIG. 5 Spherical (optional)

Enable to the Driver to Select Either: PL/Plo/Plano—Placeholder for the Number Zero; You May Leave the Fields Blank or Enter 0.00 or Enter 0.00+

(FIG. 9) 1 button—Prism—implemented in to the windshield in order to re-align them (if applicable) Compensate for eye alignment issues—Located on the bottom left side of the device or windshield

Enabling drivers to use when their two eyes are not properly aligned and looking directly at the same thing. (Base—The prism what the axis is to the cylinder) (If applicable)

(FIG. 10) 1 button touch screen or wired (optional)—DV—Distance

Vision—Locate top left of device or windshield

Enable Drivers to Use for Distance Vision in the Windshield

DV—Distance Vision

(FIG. 11) 1 button select numerical options: NV/NVO—Near Vision or Near Vision Only—Located under FIG. 10 DV—Distance Vision on left side of device or windshield

Enable drivers to use either near vision or near vision only. Drivers can have their optician implement the recommended prescription to use reading only windshield with or without other features

Adjustable options−100=−1.00 and +225=+2.25

(FIG. 12) Sensor in the center of the windshield—Millimeter Ruler Sensor—Locate in the center of the device or windshield

PD—Pupillary Distance measurement

Enable drivers self-measure the center of the pupils by looking straight into the windshield.

PDs—Pupillary Distance measurement are from 54 to 70 mm (typical adult's Pupillary Distance measurements)

PDs Pupillary Distance measurement are from 41 to 58 mm (typical children's Pupillary Distance measurements)

Total Buttons and Slide buttons—21 to 26 (Number of buttons and slides are Optional depending on the drivers preference and manufacturing)

Note: (Installations can be either wired in the motorized vehicle or electronically touch screen) (Drivers will have the options to activate half the windshield with VyO Vision and the other half Standard, Whole windshield with VyO Vision activated, or (Standard without VyO Vision activated)

FIG. 1 The method claimed VyO Vision invention is to assist motorist the opportunity to adjust any vehicle windshields provided by VyO Vision for better viewing while operating the motorize vehicles is 8 push buttons located at the top right side of the electrical device or glass windshield to select Dioptre levels of: +1.00 thru +3.25 to adjust optical viewing while operating the motorize vehicles. The electrical device or windshield with the option to adjust for nearsightedness and farsightedness.

FIG. 2 The method claimed VyO Vision invention to be used as an enhancement/implemented or integrated on any windshields such as: Aircraft, Vehicles, Military equipment, House windows, door peep holes, Trains, Space shutters, Binoculars, Security cameras, Telescopes, Motorcycles, Buses, or any type of engine operated vehicle for zoom, distance and near option assisting drivers viewing closer or adjustable viewing avoiding straining eyes while operating any motorized vehicle. FIG. 7 is pupillary distance used between the center of the drivers eyes if drivers required bifocal in one and not both eyes while driving

FIG. 3 The method claimed VyO Vision invention can be either as glass, fiberglass, or plastic including touchscreen operation and/or wired either in the dashboard or windshield option for cylinder and axis optional for drivers to adjust the windshield or electrical device as a single-vision either with prescription or without to improve reading street signs. FIG. 9 is prism implemented either in the electrical device or windshield that will compensate with eye alignment for better viewing while driving any vehicle. FIG. 10 is dv distance vision will allow drivers to adjust the windshield or electrical device to view any object either closer or far while operating any motorized vehicle.

FIG. 4 The method claimed once VyO Vision invention is on the market updates and upgrades will be implemented in windshield or electrical device for oculus sinister, dexter, or uterque for viewing while operating motorized vehicles each option can be prescribed by an optometrist. FIG. 8 is pl, plo, piano option not adjustable normally only zeroes are entered toward better viewing for drivers. FIG. 5 The method claimed is spherical adjustable to near-sighted in the windshield or optional in the electrical device assisting drivers to adjust near sight for better viewing while driving.

FIG. 6 The method claimed bifocal, trifocal, and progressive option in the windshield providing the drivers to use the windshield as eye glasses either partial windshield or whole. Enabling drivers the choice to wear their prescription eye glasses while driving or not wear the prescription eye glasses. FIG. 11 is nv or nvo the option to adjust the windshield or electrical device for viewing near viewing adjustable or preset near vision only without adjustable settings.

FIG. 12 Normal view is millimeter ruler sensor implemented either in electrical device or windshield to take record of the distance between the driver's eyes for alignment viewing. All options operated on device either touched screen on the windshield, wired in the vehicle dash-board, or in electrical device installed in all motorized vehicles; with the option to activate VyO Vision partial windshield or whole. The drivers will have all three options: standard windshield without VyO Vision activated or partial windshield or whole windshield activated with VyO Vision.

1. I claim VyO Vision invention is to assist motorist the opportunity to adjust any vehicle windshields provided by VyO Vision for better viewing while operating the motorize vehicles.

2. I claim VyO Vision invention to be used as an enhancement/implemented or integrated on any windshields such as: Aircraft, Vehicles, Military equipment, House windows, door peep holes, Trains, Space shutters, Binoculars, Security cameras, Telescopes, Motorcycles, Buses, or any type of engine operated vehicle.

3. I claim VyO Vision invention can be either as glass, fiberglass, or plastic including touchscreen operation and/or wired either in the dashboard or windshield.

4. I claim VyO Vision invention can either be touchscreen or wired

5. I claim once VyO Vision invention is on the market updates and upgrades will be implemented
